(19) United States
(12) Patent Application Publication
(10) Pub. No.: US 2024/0296458 A1
(43) Pub. Date: Sep. 5, 2024

(54) SYSTEMS AND METHODS FOR ASSET AUTHENTICATION AND MANAGEMENT

(71) Applicant: Mars 8 and Co, London, Ltd, London (GB)

(72) Inventor: Julien Marc Pecoraro, London (GB)

(21) Appl. No.: 17/795,813

(22) PCT Filed: Jul. 27, 2022
(86) PCT No.: PCT/IB2022/056921

§ 371 Date: Jul. 27, 2022

Related U.S. Application Data
(60) Provisional application No. 63/226,012, filed on Jul. 27, 2021.

(51) Int. Cl. G06Q 30/018; G06Q 30/0601; G06Q 40/03

(52) U.S. Cl. CPC G06Q 30/018; G06Q 30/0613; G06Q 40/03

(57) ABSTRACT

Distributed ledgers can be used to store information about assets of value, where that information may include model, serial number, or other information that can be used to authenticate those assets. The ledger can also include other information, such as ownership, service history, market value, condition, liens, and the like. This information can be used to authenticate an item and verify ownership, which can be important for tasks such as resale, insurance, obtaining credit, or investment.

### CROSS-REFERENCE TO RELATED APPLICATIONS

This application claims priority to and the benefit of PCT Application No. PCT/IB2022/056921, titled “SYSTEMS AND METHODS FOR ASSET AUTHENTICATION AND MANAGEMENT,” filed Jul. 27, 2022 and co-pending U.S. Provisional Patent Application No. 63/226,012, titled “SYSTEMS AND METHODS FOR ASSET AUTHENTICATION AND MANAGEMENT,” filed Jul. 27, 2021, the full disclosure of which are hereby incorporated by reference in their entirety for all purposes.

### BACKGROUND

People often have several types of assets that have monetary value, such as value on a secondary market. These people might want to perform various tasks with respect to these assets, such as to sell the assets or use them as collateral. In many instances, however, it is difficult to verify authenticity, ownership, value, insurance, and other such aspects of these assets, which may limit the ability of these people to utilize their assets to their full extent.

### BRIEF DESCRIPTION OF THE DRAWINGS

Various embodiments in accordance with the present disclosure will be described with reference to the drawings, in which:

FIG. 1 illustrates an example asset information management system that can be utilized in accordance with various embodiments.

FIG. 2 illustrates an example authentication system that can be utilized in accordance with various embodiments.

FIG. 3 illustrates an example interface of a block of a distributed ledger that can be utilized in accordance with various embodiments.

FIG. 4 illustrates an example interface of a marketplace that can be utilized in accordance with various embodiments.

FIG. 5 illustrates an example interface of a marketplace that can be utilized in accordance with various embodiments.

FIG. 6 illustrates an example flow chart of a process for authenticating an asset that can be utilized in accordance with various embodiments.

FIG. 7 illustrates an example flow chart of a process for preparing a transaction associated with an asset that can be utilized in accordance with various embodiments.

FIG. 8 illustrates example components of a computing device that can be utilized to implement aspects of various embodiments.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Embodiments of the present disclosure may be directed toward systems and methods to overcome at least the above-referenced problems with verification of assets. Specifically, systems and methods may be directed toward an authenticity service that enables a user to register, verify, and track assets through a lifecycle for one or more purposes, such as for sales, for use as collateral, for insurance registration, and the like. In at least one embodiment, assets, which may be physical assets, may be evaluated and verified for authenticity, ownership, quality, and the like. Verification may include evaluation by one or more trusted parties, such as a trusted expert, that may perform an examination of an item, which may include performing a physical examination of an item. Upon verification, records associated with the item may be stored, such as within a distributed ledger. These records may then be used to provide verification and assurances when the item is sold or offered for collateral, as a receiving party may be able to access the information within the distributed ledger to verify authenticity, and as a result, verify value of the item. Users of the service may then be able to offer their items for sale, offer their items as collateral, or track ownership for insurance purposes, among other uses.

Systems and methods may provide an authentication service that may be integrated into, or associated with, one or more online marketplaces. The authentication service may include an authenticity manager which may provide access to various experts when a user requests authentication of one or more items. For example, a database of experts may be maintained, which may include areas of expertise, location, costs, and the like, and the user may receive a list of potential experts to provide services. Different experts may be ranked or their credentials may be presented. Upon being verified, the items may receive an icon or other distinguishing feature within the online marketplace, thereby providing an improved level of assurance to potential purchasers of the authenticity of the item. Such verification and indication may reduce levels of fraudulent dealing within online marketplaces because users may be more likely to purchase authenticated goods and, knowing that authentication services are available, may be suspicious or otherwise avoid non-authenticated goods in favor of others. The authentication service may also be used with different services or may be a stand-alone authentication service that provides credentials to a user for later use, for example, by providing the credentials to an insurer when obtaining coverage. In at least one embodiment, authentication may run with a lifecycle of the item through different owners to illustrate chain of title and also demonstrate that authentic items were provided along the entire chain.

Various embodiments may incorporate one or more features of a distributed ledger, which may be referred to as a blockchain, and/or non-fungible tokens (NTFs) with the authentication service and/or with an online marketplace. For example, ownership and authentication information associated with an item may be tracked on a blockchain and then updated when transfer of the asset is completed. By tracking ownership through the distributed ledger, a purchaser or borrower may be more confident that the offeror actually has ownership and possession of the asset. Furthermore, NFTs may be used to store information about the item, track ownership, track manufacturing, and the like. Additionally, in at least one embodiment, NFTs may be used to transfers deeds of ownership of various items. The use of the distributed ledger may also be coupled with the use of one or more digital currencies (e.g., coins) that may be used to purchase items, but it should be appreciated that various other currencies or items may be used to facilitate transfer of products (e.g., fiat currencies, precious metals, etc.).

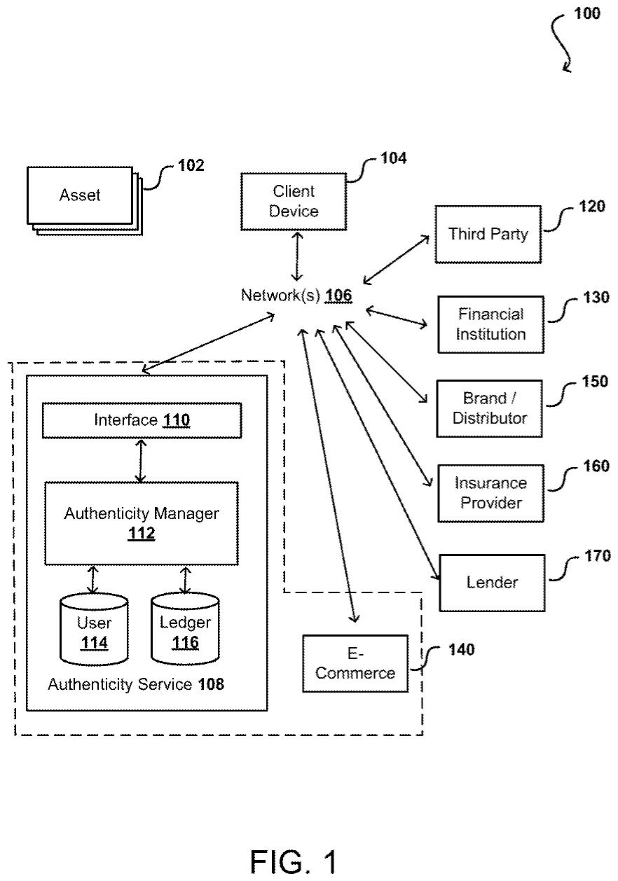

FIG. 1 illustrates components of an example asset information management system 100 in accordance with at least one embodiment. It should be understood that this is just one example for purposes of explanation, and there can be various other components and configurations utilized within the scope of the various embodiments and discussed and suggested herein. A user of such a system might have various assets 102 that may have at least some monetary value. These may include, for example, items or personal property such as watches, cars, computers, real estate, artwork, wine, furniture, jewelry, and so on. In other situations a user may want to acquire or otherwise engage in a transaction involving such assets. For items such as watches, however, it can be difficult to prove that the watch is authentic and that a purported owner actually has proper title or ownership in that asset.

Approaches in accordance with various embodiments can leverage the power of distributed ledgers, such as blockchains or NFTs, to track information such as authenticity, ownership, condition, service history, market value, and other such information. In at least one embodiment, a service provider might provide an authenticity service 108 that can manage at least some of this information. A user having an asset 102 can utilize a client device 104 to access the authenticity service 108 over at least one network 106. The client device 104 can be any appropriate client device, such as a desktop or notebook computer, tablet, smartphone, wearable computer, or other such device. The network(s) can include any appropriate network, such as a cellular network, Internet, local area network, peer network, or any other wired and/or wireless communication network. An authenticity service can include any appropriate set of computing components, such as may include servers, routers, load balancers, interfaces, storage devices, and other such components for tasks such as receiving, managing, and processing data.

As an example, a user might purchase a luxury watch. In one example, the user can utilize the client device 104 to access the authenticity service, such as through an app or a website. The user can input information about the watch, such as model and serial number. The authenticity service can check information in a distributed ledger 116 to determine whether the service stores information for that watch, or asset. The service might also contact a brand or distributor system 150 for information about the asset, such as to confirm its existence, any chain of title, or other such information, which may already be stored in a distributed ledger. In another example, when an asset is sold by a brand or distributor the brand or distributor system 150 may send information to the authenticity service 108 indicating that the watch exists with certain information, and may include information about the purchaser. Any or all of this information can be used to generate or update a distributed ledger 116 to which the authenticity service has access. The authenticity service can also store user information 114 for its various users, and can link those users to their various assets.

Once an authenticity service has this information, this information can be utilized for various purposes. In one example, this information can be used to verify the authenticity and ownership of an asset that is for sale. If the asset is for sale through an electronic marketplace 140, or online store, the electronic marketplace might send a request that is received by an interface layer 110 of the authenticity service 108, which can direct the request to an authenticity manager 112, which may comprise at least an authenticity application running on a computer or server, which may be physical or virtual. In other embodiments, as illustrated by the dotted line in FIG. 1, the electronic marketplace may be part of the same system or environment offered by the same provider, such that the electronic marketplace and authenticity manager can share information stored to similar databases or accessible from similar sources. It should be appreciated that the authenticity service 108 may also interface with or otherwise provide information to a separate marketplace 140 that is not associated with the service 108. For example, the authenticity service 108 may be provide services to a marketplace 140 that sells high-end goods in order to provide third-party verification of items to improve customer confidence in their purchases. The authenticity manager 112 can compare the information from the electronic marketplace against the information in the corresponding distributed ledger 116 to determine specific information, such as whether the asset exists, whether there is clean title or chain of ownership, whether there are any liens on the asset, a current condition or value, or other such information. In at least one embodiment, the authenticity service may not provide information about the user or other personal information, but may at least provide an indication of whether the item can be verified as existing, having no liens, and not having any known ownership issues. If all these come back acceptable, the electronic marketplace 140 can display an icon or other indicator that enables a user to determine that the asset is valid and can be purchased with confidence. If the asset has certain issues, such as a lien or gap in ownership, then a different icon may be displayed. If the asset cannot be authenticated then another icon might be displayed or the asset might be removed from the marketplace. If the asset is listed as stolen, the item will be removed from the marketplace and not available for purchase. A third party 120, such as someone interested in purchasing an asset, may also be able to submit information about an asset and receive back at least an indication of authenticity. The electronic marketplace can offer or support other types of transactions as well. As discussed elsewhere herein, users may be able to take options on specific goods or assets, publicly list assets such that others can make offers or contact if interested, or provide for bartering or trades involving those assets. For example, a user may not be particularly interested in selling an item that has been in the family for an extended period of time. The user may enter that item in the system for tracking purposes, and may choose to make listing of that item public. If there is a buyer who is very interested in that item that is willing to offer a premium, the user may be willing to receive those offers and consider whether to engage in a transaction through the system.

In some embodiments there may be more than one marketplace, which each may be associated with, or separate from, the authenticity service 108 and may be provided by one or more parties. A first marketplace can enable authenticated goods to be offered for sale, rent, lease, barter, or other such purposes. A second marketplace can enable assets to be used as collateral. For example, a user may list assets that lenders (e.g., retail lenders, banks, or crowdfunding sources) or financial institutions can view to determine whether to offer cash, a loan, or other financial offerings, based at least in part upon the value or equity in those assets. Similarly, a lender 170 or financial institution 130 may offer specific financial offerings or options, and a user may be able to provide information about specific assets to attempt to obtain one or more of those financial offerings using those assets as at least part of the necessary collateral. Such information can be used to place funds into the system, as well as to be able to determine applicable rates, such as to provide a 3% yield for Rolex watch assets in North America or a 4.5% yield for Porsche and gold assets in Asia. Users can have the ability to discriminate in such a system, after seeing what is available or offered through the system or service. A user, such as a financial institution, can determine whether to accept one or more assets as collateral and offer a product such as a line of credit, whereby users can lend or obtain funds through this system in any type of currency.

In another example of a financial offering, a person may need access to cash. While a user could travel to a location such as a pawn shop and leave the item with the shop for a period of time in exchange for access to cash, the ability to authenticate an item and determine ownership can enable the user to obtain cash without having to travel to a physical location or temporarily give up possession of the asset. In one embodiment, a user can interact with a financial institution 130 or lenders 170 to attempt to obtain cash or a line of credit. It should be understood that although shown as separate entities, systems such as an e-commerce site 140, financial institution 130, insurance 160, and authenticity service 108 might be offered by a single entity. A user might be able to specify ownership of one or more assets to the financial institution 130. The institution can send information to the authenticity service 108 (or the user can send the information) and the financial institution can receive back information confirming that the user owns or has title to those items, and that those items are authentic. If available and permitted, the financial institution or lenders may also be able to obtain information such as value, condition, and service history. The financial institution can then determine a value for the asset(s) listed by the user, and can determine a line of credit or amount of cash that can be offered to that user. The user can determine whether to take all, or a portion, of that amount in cash or credit, and in which type of currency. This can be reflected in the distributed ledger 116 for those assets, such that those assets may be unable to be sold or transferred, or used for other financial purposes, while they are used as collateral for cash or credit. Once a user closes the line or returns the cash, the ledger can be updated and the asset available for any and all purposes. If the user defaults, then the user will be responsible for turning over the item or taking another such action. The default will be entered into the distributed ledger, such that the user cannot sell or transfer the asset. Furthermore, defaults may also be associated with contract rights, allowing the lending party to repossess or otherwise take possession of the item, if the item was maintained by the user. For example, if the item is a watch that is offered as collateral, a portion of the agreement may include a contract specifying terms in which the lending party may repossess or otherwise obtain the watch, or an equivalent cash value of the watch. Upon default, the lending party may then proceed through one or more appropriate channels to obtain possession of the item.

In another example, this credit can be used for investment purposes. Instead of receiving a line of credit, a user can obtain an amount of investment for those assets. For example, if the user is willing to invest a portion of the value in these assets, that value can be invested and the user can earn interest without giving up possession of those items or submitting any cash. In this way, a user can earn interest on the value of his or her items while still being able to enjoy those items. The user in some embodiments may receive an amount of secured, collateralized credits for investment purposes. As noted above, when offering items as collateral, an associated contract right may be provided to the lending party to obtain possession in the event of a default or margin call. For example, if the user offered an item as collateral for an investment and the investment increased in value, the user may receive the difference between the item value at the time of investment and the current value of the investment. However, if the user offered an item as collateral for an investment and the investment value decreased in value, the user may receive a margin call to either surrender the item or to provide equivalent value of the difference in value.

In at least one embodiment, there may be one or more currencies specified for use in such a system, such that values and offers all use a specified currency. Such a standard of currency may be monetary using a basket of currencies, and/or may include a new currency such as a specified cryptocurrency. In at least one embodiment, a specified cryptocurrency may be initiated or made available by a provider of the authenticity management system or other related system. This standard of exchange can be used for various purposes within the system, such as for bartering options, collateral options, financing, credit, or investment. The cryptocurrency can be based upon, for example, assets, exchange, and collateral. In at least one embodiment, this cryptocurrency can be engineered or managed using a proprietary algorithm of the authenticity management provider or system. In some embodiments, a single provider can then offer a system that combines a marketplace with ability to provide for financing or investment of specific assets, along with a standard of exchange that can be used for these and other types of transactions through the marketplace.

The distributed ledger 116, such as an asset-specific blockchain, can also be used to enforce rules on ownership or transfer. For example, a user might purchase a rare automobile that has restrictions on resale. This may include, for example, an agreement not to sell the vehicle for a minimum period of time, or an agreement whereby the dealer or distributor has to receive the first opportunity to purchase the vehicle. This information can be reflected in the distributed ledger, and can be used to determine whether an item can be available for purchase, etc. If the item is to be offered through an electronic marketplace, the marketplace receiving this information may automatically delist the asset, or may at least provide indication that the transaction may have restrictions. Such ledgers can also enable a brand, retailer, or distributor to keep track of ownership of its items in certain cases.

In some instances, a user may need to take an item to an authorized entity to have an asset verified, such as to an authorized jeweler or brand representative to have a watch verified as authentic. The entity can then enter this information into the system, which can be added to the distributed ledger. A user may also have to update information over time, whether based on any changes of which the user is aware or as part of an audit process or other such aspect of the system. For example, a user may need to make periodic verifications of ownerships, such as for assets such as smartphones that a user is likely to only keep for a limited amount of time, or for high value items that are used for significant amounts of collateral or financing. For assets such as vehicles, this may include regular updates as to mileage, condition, service, or accidents. Audits or verifications in some embodiments may be performed randomly or at regular intervals, with certain types of items, or items with certain amounts of value in the system, weighted more heavily and thus more likely to receive a random audit. Information updates can come from other parties or entities as well, such as brands or financial institutions that track or store at least some relevant information for at least some of these assets, or offerings made based at least in part upon these assets. For certain types of items, or specific high value items, there may be additional information to be provided as well. For example, for high value assets such as vehicles or jewelry, it may be a requirement for certain transactions that a geo-tracker or other mechanism be utilized that can provide real-time asset location information for that item, at least while that item is used for collateral or other such purposes. The system can then provide notifications of movement or changes involving that asset to the relevant party or parties.

A user can also utilize an app or website to obtain information about all that user's assets that are in the system, such as to obtain a current value or update service or condition information. In some embodiments, information for any servicing or valuation provided by an authorized entity can be added to the distributed ledger for the respective asset. A user can have sole access to certain information, and can determine which other entities should have access, as well as which subset of data for which to grant access. For example, a user might want to share all this information with an insurance provider 160 in order to obtain a proper amount of insurance, as well as to be able to verify a claim if an asset is stolen or damaged. If an insurance company pays out a claim and that asset later is recovered or identified in the system, then the insurance company can determine how to pursue a claim against that item or determine how to return it to the user. A user can also be notified of any changes to any ledger associated with one of that user's assets.

In some embodiments, such as where allowed through regulation or user permission, there can be at least some amount of tracking or data collection regarding usage of such a system. This can include, for example, the types of assets or transactions in which a user has engaged or expressed interest, as well as information about those transactions. Information and data traffic about user patterns and preferences, for example, can then be provided to other parties, such as brands, users, e-commerce, or financial institutions. These parties can then provide some type of compensation for this market analysis data, such as may involve cryptocurrency through the system. Such data can be used for other purposes as well, such as for social media optimization (SMO), search engine advertising (SEA), or search engine optimization (SEO), such as where displayed recommendations, advertisements, or content to be displayed are presented based, at least in part, upon this market analysis data and tracking. In at least some embodiment, a customer relationship management (CRM) system can be provided or utilized for at least some types of users, user data origin, to enable access to information, analysis, creative work, and reporting, among other such options.

A computerized environment such as that in FIG. 1 may include various types of resources that can be utilized by multiple users for a variety of different purposes. As used herein, computing and other electronic resources utilized in a network environment can be referred to as “network resources.” These can include, for example, servers, databases, load balancers, routers, and the like, which can perform tasks such as to receive, transmit, and/or process data and/or executable instructions. In at least some embodiments, all or a portion of a given resource or set of resources might be allocated to a particular user or allocated for a particular task, for at least a determined period of time. The sharing of these multi-tenant resources from a provider environment is often referred to as resource sharing, Web services, or “cloud computing,” among other such terms and depending upon the specific environment and/or implementation. In this example the provider environment includes a plurality of resources of one or more types. These types can include, for example, application servers operable to process instructions provided by a user or database servers operable to process data stored in one or more data stores in response to a user request. As known for such purposes, a user can also reserve at least a portion of the data storage in a given data store. Methods for enabling a user to reserve various resources and resource instances are well known in the art, such that detailed description of the entire process, and explanation of all possible components, will not be discussed in detail herein.

A resource manager (or another such system or service) in this example can also function as a virtual layer of hardware and software components that handles control functions in addition to management actions, as may include provisioning, scaling, replication, etc. The resource manager can utilize dedicated APIs in the interface layer, where each API can be provided to receive requests for at least one specific action to be performed with respect to the data environment, such as to provision, scale, clone, or hibernate an instance. Upon receiving a request to one of the APIs, a Web services portion of the interface layer can parse or otherwise analyze the request to determine the steps or actions needed to act on or process the call. For example, a Web service call might be received that includes a request to create a data repository.

An interface layer in at least one embodiment includes a scalable set of user-facing servers that can provide the various APIs and return the appropriate responses based on the API specifications. The interface layer also can include at least one API service layer that in one embodiment consists of stateless, replicated servers which process the externally-facing user APIs. The interface layer can be responsible for Web service front end features such as authenticating users based on credentials, authorizing the user, throttling user requests to the API servers, validating user input, and marshalling or unmarshalling requests and responses. The API layer also can be responsible for reading and writing database configuration data to/from the administration data store, in response to the API calls. In many embodiments, the Web services layer and/or API service layer will be the only externally visible component, or the only component that is visible to, and accessible by, users of the control service. The servers of the Web services layer can be stateless and scaled horizontally as known in the art. API servers, as well as the persistent data store, can be spread across multiple data centers in a region, for example, such that the servers are resilient to single data center failures.

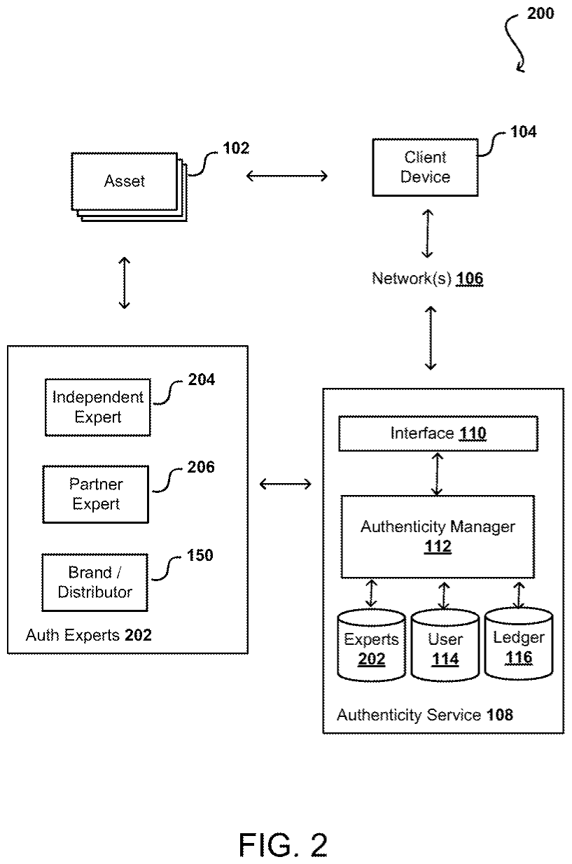

FIG. 2 illustrates an example authentication environment 200 where assets 102 are provided for physical or digital examination by one or more authorized experts. As noted, assets 102 may include digital or physical assets own by one or more users, such as clothing, watches, jewelry, cars, art, real estate, and the like. In certain embodiments, these assets may be considered as “high end” assets, where a supply may be limited. By way of example only, certain brands may be considered to be “high end” due to limited releases or the price point for items. Accordingly, these particular items may be difficult to obtain, such as shoes that have a limited release at particular stores that are limited to a certain number of pairs or wines with a certain vintage from a particular distributor. The user may use the client device 104 in order to authenticate their assets 102 via the authenticity service 108, which as noted above may be a separate entity or may be associated with one or more online marketplaces. The authenticity manager 112 may receive a request from the user and may, in certain embodiments, request additional verifying detail from the user. By way of example, the user may provide a serial number, proof of purchase, or other piece of information that enables the authenticity manager 112 to determine whether ownership or a verification of authenticity is already recorded within one or more distributed ledges 116. If not, and the information provided by the user is insufficient for independent verification, then the authenticity manager 112 may provide recommendations for one or more authentication experts 202 to verify or otherwise evaluate the asset 102.

It should be appreciated that the authenticity manager 112 may deploy one or more automated techniques to verify authenticity prior to, or in parallel with, recommending one or more authentication experts 202. For example, if a user submits a serial number with an item, the authenticity manager 112 may compare that number against a database to verify authenticity of an item, where the database may also include information such as the buyer's name, purchase location, and the like. Accordingly, authentication may be provided in an automated process. A threshold number of points or features may be checked to determine whether an item is authentic. Additionally, the points or features may vary by product. By way of example only, if the user is trying to authenticate a pair of sneakers, a serial number and photograph may be insufficient to authenticate the sneakers because the photograph may not include enough angles, may be poorly lit, or may not show each element of the sneaker. However, in contrast, verification of ownership of a watch may be automatically performed where the owner has purchased the watch from an authorized dealer that can provide information to corroborate information provided by the user.

In various embodiments, authentication experts 202 may be partners or otherwise be credentialed experts within one or more fields that have knowledge for determining authenticity of one or more assets. For example, one set of experts may specialize in determining authenticity of works of art while another may specialize in determining authenticity of clothing. Experts 202 may also include services that may evaluate a condition of an item, such as checking on a mechanical condition of a car. These experts may be partnered with the authentication service 108, for example be certified by the service 108, or may be third party independent experts that, through their reputation, have demonstrated an expertise such that their evaluation of assets is trustworthy.

The user may then provide the assets 102 to one or more selected authentication experts 202. For example, recommendations from the authentication service 108 may provide a list of experts close by to the user. In another example, the user may ship or bring the expert to a location for evaluation of the assets 102. As noted above, various different persons or parties may be considered experts, such as a brand/distribution 150, an independent expert 204, or a partner expert 206. In at least one embodiment, one or more agreements may be put in place that permit the experts to provide information back to the authentication service 108. For example, the experts may provide their opinion on authenticity/condition of an item and include such information in a communication to the authenticity service 108 to be included within the distributed ledger 116 associated with a particular asset. The agreement may also include contingencies that the expert provide information regardless of their evaluation. That is, the expert may provide information regarding both positive and negative evaluations of authenticity. In this manner, the user cannot attempt to visit multiple experts and only provide information from an expert providing a preferred evaluation. Such a system may reduce a likelihood of “expert shopping” that may lead to improper or otherwise fraudulent evaluations. In at least one embodiment, evaluations may include information about which expert provided their opinion and how they came to such an opinion. Over time, data may be collected and experts may be ranked, for example by a quality of their evaluation, such as when different experts come to a similar conclusion. By providing information directly to the authenticity service 108, the user not only has less work to do, but there is also a reduced likelihood that the user will try to obfuscate or otherwise skew the results they obtain from the evaluation.

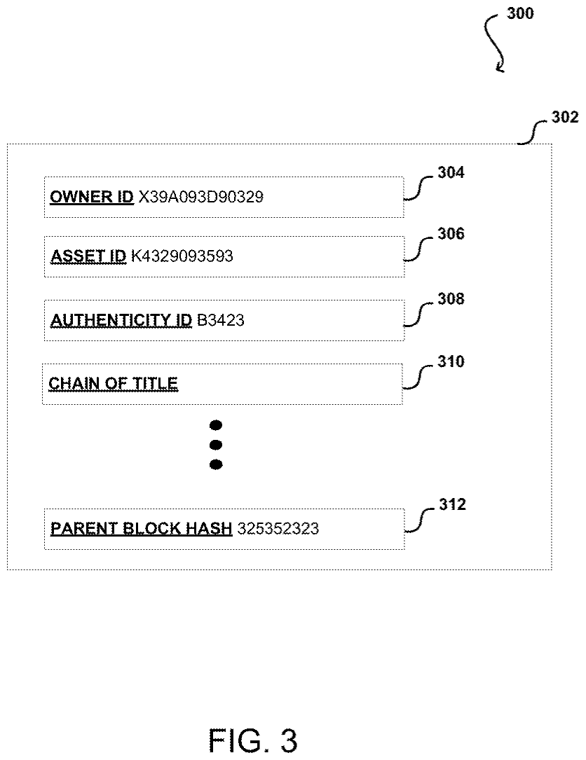

FIG. 3 is an example interface 300 of a block 302 within a distributed ledger 116 corresponding to asset information. In this example, the block 302 includes information regarding ownership 304 of the asset, asset ID 306 to identify the particular asset (which may include additional embedded information, such as a serial number), an authenticity ID 308 to identify a particular expert that provided authentication services, chain of title 310, and a parent block hash 312. As shown, the data in the block 302 has been anonymized in order to guard the identity of the owner because, in certain embodiments, owners may not want ownership of certain assets publicly broadcast. It should be appreciated that this information within the block 302 is provided by way of example only and is not intended to limit the information that may be recorded within the block 302 and/or to restrict the information that may be associated with different assets. For example, one or more restrictions may also be recorded within the block 302, such as a restriction on sale until a period of time or a requirement to have the asset serviced at regular intervals, among other options.

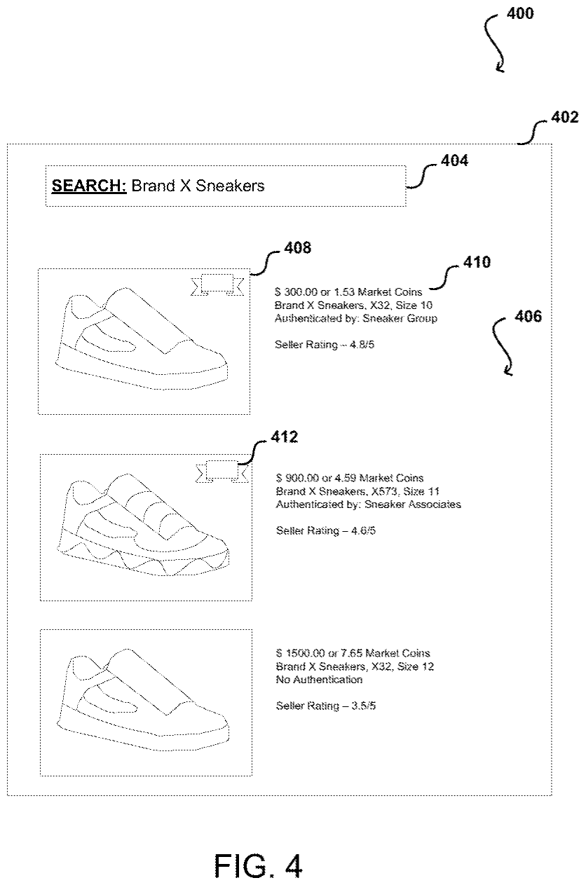

FIG. 4 is an example interface 400 for a marketplace store front 402 including product listings available for purchase that may be associated with an authentication service. In this example, the store front 402 includes a search bar 404 where a user can enter a search query that may be evaluated against one or more indexes associated with the marketplace. A set of results 406 is provided responsive to the query and, in this example, includes item photos 408 along with a description 410 for each item. As shown, indicators 412 are provided for items that are authenticated. However, items without authentication do not have the indicator 412, thereby providing a rapid way for a user to visually check a status of the items they may be purchasing.

A user may then browse through their search results and evaluate information for their intended purchases to determine whether they want to proceed. If so, the user may transmit the appropriate purchase price and then the ownership information may be updated within the distributed ledger and the item may be prepared for shipment to the user. In various embodiments, authentication may persist with the item. However, in other embodiments, the user may need to re-authenticate or otherwise provide a verification of authenticity if, for example, the user intends to re-list the product at a later date. The updates to authenticity may be used to verify that the item remains in a suitable condition or to ensure that one or more portions have not been swapped or otherwise replaced that may reduce a value of the item. In this manner, the lifecycle of the item may be continuously monitored at each individual sale.

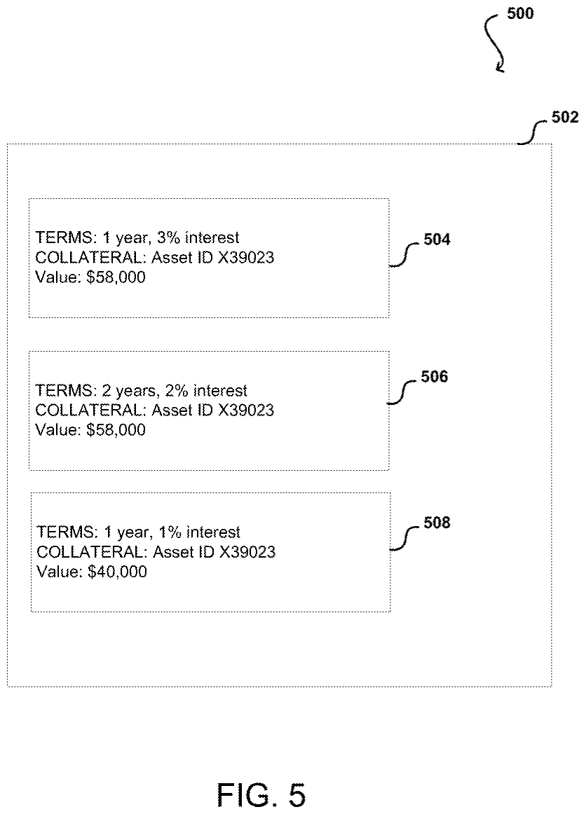

FIG. 5 illustrates an interface 500 associated with a lending system that may utilize one or more items as collateral for loans and/or investments. In this example, a landing page 502 may provide the user with different options 504, 506, 508 for loan conditions where one or more user assets are being used as collateral for the loan. For example, the option 504 may include a term of 1 year at 3% interest while providing a value of $58,000 for a particular asset. However, the option 506 may provide the same term with a lower interest rate, but only give a lower value of $40,000 for the same asset. In this manner, the user may be able to offer different assets that they have stored within the service and lenders may bid or otherwise provide terms for providing loans backed by those assets. Accordingly, the user may be provided with different potential options where the lenders may bid to receive business from the user.

In various embodiments, the user may maintain the assets and the right to use the assets during the term of the loan. For example, if the asset is a car, the user may consider to drive the car, however, the lender may provide different restrictions or terms, which may be recorded within the distributed ledger along with the note for the loan. The lender may restrict a number of miles that may be driven, require insurance of a certain type on the car, and may require regular maintenance, among other options. Upon repayment of the loan, the ledger may be updated to show that there is no longer an encumbrance on the title of the car. However, if the user defaults, the title for the car may revert to the lender, which may then proceed with one or more options to obtain possession of the vehicle.

Various embodiments may provide a loan marketplace where lenders may request or otherwise look for certain assets that they wish to receive as collateral for loans. For example, particular lenders may wish to receiver jewelry or precious metals, while others may wish to have art work or vehicles. Such a marketplace could allow both users and lenders to receive more competitive rates than a local bank or credit union, which may have less desire to receive certain items as collateral. Additionally, different terms may be negotiated or otherwise presented based on factors such as geographical location. For example, a lender may be more willing to lend on assets that are currently in a country with stronger properly laws or that is easier to access, as opposed to an asset located at a remote island that will be difficult to obtain in the event of a default.

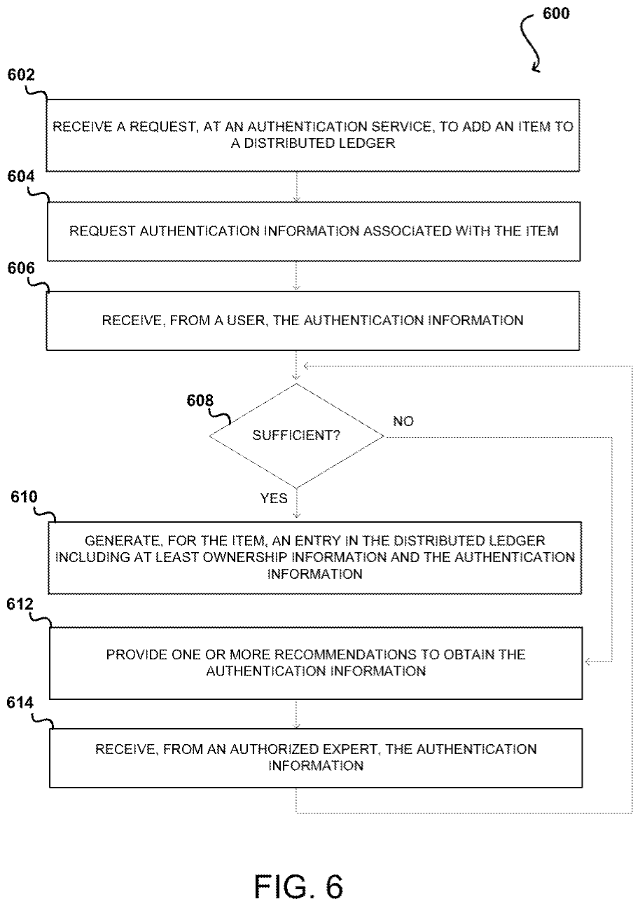

FIG. 6 is a flow chart of an embodiment of a process 600 for adding an authorized asset to a distributed ledge. It should be appreciated that for this process, and all processes described herein, that there may be more or fewer steps. Additionally, the steps may be performed in a different order, or in parallel or partially in parallel, unless otherwise stated. In this example, a request is received to add an item to a distributed ledger 602. The request may be provided from a user that owns one or more assets to be added to the distributed ledger, where adding the asset may facilitate tracking ownership, condition, and the like for the asset. The asset may be a physical asset that may be provided for sale in an online marketplace and/or may be used as collateral for loans, among other options. Furthermore, the asset may be a digital asset. In at least one embodiment, adding the asset to the distributed ledger does not cause the user to give up possession or cease use of the asset.

The authentication service may receive the request and then request additional authentication information from the user 604. For example, the authentication information may correspond to a serial number associated with the asset, a proof of purchase, a certificate of authenticity, or the like. In at least one embodiment, the authentication information may be ownership documentation, such as a title. However, for certain assets, such information may be difficult to obtain. For example, items such as clothing or art work may be replaced with forgeries that may appear to be the authentic work, but are not. As a result, additional levels of authentication may be necessary in order to provide confidence that the asset is as stated. The authentication service may receive the authentication information 606 and determine whether it is sufficient 608. Sufficiency may be based, at least in part, on a set of rules for different assets. For example, if the asset is a vehicle, sufficiency may include whether or not a title is provided, whether maintenance records are provided, or the like. Similarly, authentication information provided directly from a manufacturer may also be considered, such as a serial number from a provider. Accordingly, sufficiency of the information may be based, at least in part, on one or more sufficiency factors, where a threshold number of factors may need to be satisfied in order to authenticate the asset. If the authentication information is sufficient to verify the asset, then an entry in the distributed ledger may be created 610.

In certain embodiments, the authentication information may not be sufficient. For example, the user may provide a photograph of an item with no information to show that the item is owned by the user or that the item it, in fact, the item being represented. The authentication service may then provide one or more recommendations, to the user, to obtain necessary authentication information 612. For example, the authentication service may direct the user toward one or more experts that can evaluate, appraise, and authenticate the asset. In at least one embodiment, the authentication service may receive the additional authentication information directly from the experts 614. However, it should be appreciated that the experts may provide information to the user to then provide to the authentication system. In this manner, each item added to the ledger via the authentication service may be validated for authenticity and ownership, which may increase a confidence level for users in an associated marketplace with respect to purchasing or taking the assets as collateral for loans.

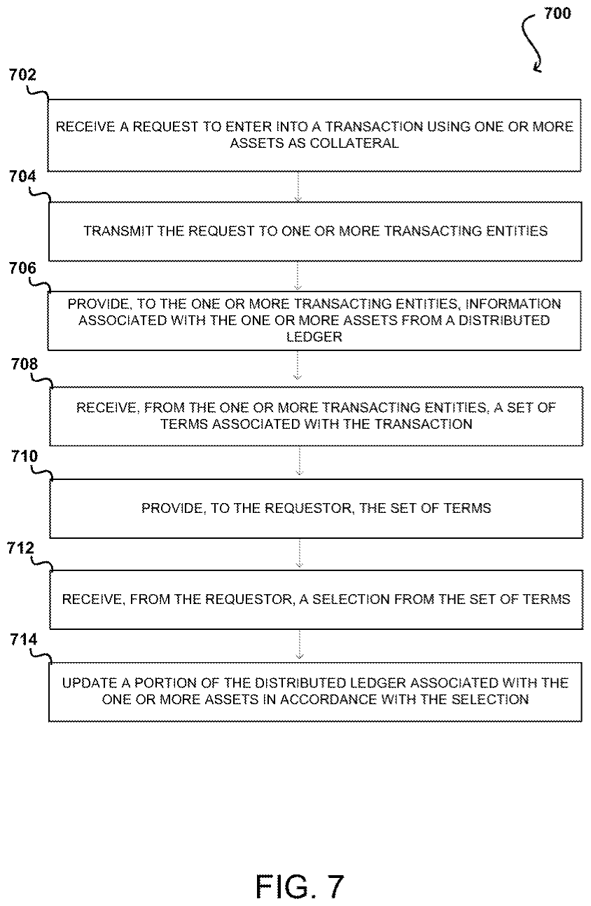

FIG. 7 is a flow chart for a process 700 for updating a distributed ledger in accordance with a transaction associated with an asset. In this example, a request is received to enter into a transaction using one or more assets as collateral 702. For example, a user may own one or more assets, which may be authenticated assets that are stored or otherwise accessible via a distributed ledger, and may wish to obtain a loan or enter into an investment arrangement using the one or more assets as collateral. The user may navigate to an online marketplace and submit the request, such as a request for a certain type of transaction, a certain expected rate of return, or the like.

The request may be received at the authentication service and/or at a marketplace and then transmitted to one or more transacting entities 704. The transacting entities may include financial institutions, lenders, investors, third parties, and the like. For example, the transacting entities may vary based on the type of assets being offered as collateral, where certain entities may be more interested in different types of collateral assets. The transacting entities that are potentially interested in the transaction may then receive information associated with the one or more assets, which may be stored in a distributed ledger 706. The information may include chain of title information, authentication information, and the like. In at least one embodiment, the assets may be physical assets, such as watches, jewelry, artwork, clothing, or the like. While these assets may have value, at least a portion of that value may be tied to authenticity of the item, such as the brand or designer associated with the asset. The authenticity information may be used to show that the user actually has ownership of the item, that the ownership is valid, and that the item is as it is advertised. The transacting entities may then provide a set of terms to enter into one or more transactions 708. Sets of terms may include loan terms, interest rates, rates of return, restrictions on the assets during a period of time, and the like.

In at least one embodiment, a marketplace is used to provide the set of terms to the requestor 710. The requestor may have a list of potential transacting entities each offering different terms in which the assets act as collateral. This may provide improved terms for the requestor, as opposed to a “take it or leave it” negotiation at a pawn shop or with a bank or credit union. The user may then select a set of terms to complete the transaction 712. Information regarding the transaction may then be used to update the distributed ledger associated with the one or more assets 714. For example, a note may be added to indicate that the ownership of the asset is no longer unencumbered. Additionally, one or more restrictions may be included on the one or more assets, such as restrictions of sale, maintenance requirements, and the like.

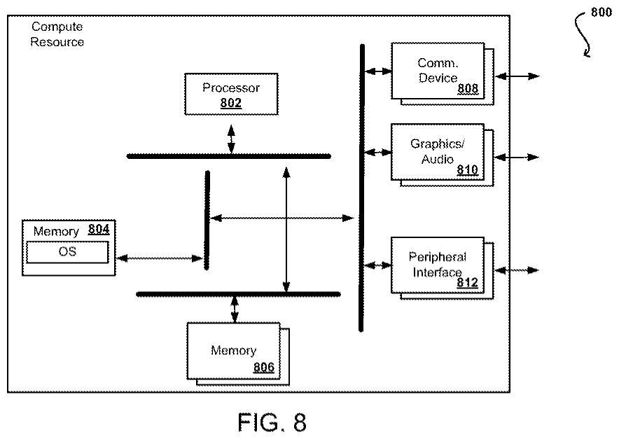

Computing resources, such as servers or personal computers, will generally include at least a set of standard components configured for general purpose operation, although various proprietary components and configurations can be used as well within the scope of the various embodiments. FIG. 8 illustrates components of an example computing resource 800 that can be utilized in accordance with various embodiments. It should be understood that there can be many such compute resources and many such components provided in various arrangements, such as in a local network or across the Internet or “cloud,” to provide compute resource capacity as discussed elsewhere herein. The computing resource 800 (e.g., a desktop or network server) will have one or more processors 802, such as central processing units (CPUs), graphics processing units (GPUs), and the like, that are electronically and/or communicatively coupled with various components using various buses, traces, and other such mechanisms. The processor 802 can include memory registers and cache memory for holding instructions, data, and the like. In this example, a memory device 804 may be provided in the form of physical RAM or RAM, which can include the code for an operating system as well as various other instructions and data utilized for operation of the computing device. Additional memory devices 806 may also be provided as one or more storage devices that may include hard drives, flash drives, optical storage, and the like, for persisting data and instructions similar, or in addition to, those stored in the processor and memory.

The processor 802 can also communicate with various other components via a bus (e.g., an interface bus, a graphics bus, etc.), where those components can include communications devices 808 such as cellular modems or network cards, media components 810, such as graphics cards and audio components, and peripheral interfaces 812 for connecting peripheral devices, such as printers, keyboards, and the like. Various other or alternative components and configurations can be utilized as well as known in the art for computing devices.

At least one processor 802 can obtain data from memory 804, 806, such as a dynamic random access memory (DRAM) module. The data in memory may be managed and accessed by a memory controller, such as a DDR controller, through the coherency fabric. The computing device 800 can also support multiple I/O devices using a set of I/O controllers connected via an I/O bus. There may be I/O controllers to support respective types of I/O devices, such as a universal serial bus (USB) device, data storage (e.g., flash or disk storage), a network card, a peripheral component interconnect express (PCIe) card or interface 812, a communication device 808, a graphics or audio card 810, and a direct memory access (DMA) card, among other such options.

An operating system (OS) running on the processor 802 can help to manage the various devices that may be utilized to provide input to be processed. This can include, for example, utilizing relevant device drivers to enable interaction with various I/O devices, where those devices may relate to data storage, device communications, user interfaces, and the like. Such a device may be used, for example, as a server in a server farm or data warehouse. Server computers often have a need to perform tasks outside the environment of the CPU and main memory (i.e., RAM). For example, the server may need to communicate with external entities (e.g., other servers) or process data using an external processor (e.g., a General Purpose Graphical Processing Unit (GPGPU)). In such cases, the CPU may interface with one or more I/O devices. In an illustrative embodiment, a host computing device is associated with various hardware components, software components and respective configurations that facilitate the execution of I/O requests.

As discussed, different approaches can be implemented in various environments in accordance with the described embodiments. As will be appreciated, although a network-or Web-based environment is used for purposes of explanation in several examples presented herein, different environments may be used, as appropriate, to implement various embodiments. Such a system can include at least one electronic client device, which can include any appropriate device operable to send and receive requests, messages or information over an appropriate network and convey information back to a user of the device. Examples of such client devices include personal computers, cell phones, handheld messaging devices, smartphones, tablets, laptop computers, set-top boxes, personal data assistants, electronic book readers and the like. The network can include any appropriate network, including an intranet, the Internet, a cellular network, a local area network or any other such network or combination thereof. Components used for such a system can depend at least in part upon the type of network and/or environment selected. Protocols and components for communicating via such a network are well known and will not be discussed herein in detail. Communication over the network can be enabled via wired or wireless connections and combinations thereof. In this example, the network includes the Internet, as the environment includes a Web server for receiving requests and serving content in response thereto, although for other networks, an alternative device serving a similar purpose could be used, as would be apparent to one of ordinary skill in the art.

The illustrative environment includes at least one application server and a data store. It should be understood that there can be several application servers, layers or other elements, processes or components, which may be chained or otherwise configured, which can interact to perform tasks such as obtaining data from an appropriate data store. As used herein, the term “data store” refers to any device or combination of devices capable of storing, accessing and retrieving data, which may include any combination and number of data servers, databases, data storage devices and data storage media, in any standard, distributed or clustered environment. The application server can include any appropriate hardware and software for integrating with the data store as needed to execute aspects of one or more applications for the client device and handling a majority of the data access and business logic for an application. The application server provides access control services in cooperation with the data store and is able to generate content such as text, graphics, audio and/or video to be transferred to the user, which may be served to the user by the Web server in the form of HTML, XML or another appropriate structured language in this example. The handling of all requests and responses, as well as the delivery of content between the client device and the application server, can be handled by the Web server. It should be understood that the Web and application servers are not required and are merely example components, as structured code discussed herein can be executed on any appropriate device or host machine as discussed elsewhere herein.

The data store can include several separate data tables, databases or other data storage mechanisms and media for storing data relating to a particular aspect. For example, the data store illustrated includes mechanisms for storing content (e.g., production data) and user information, which can be used to serve content for the production side. The data store is also shown to include a mechanism for storing log or session data. It should be understood that there can be many other aspects that may need to be stored in the data store, such as page image information and access rights information, which can be stored in any of the above listed mechanisms as appropriate or in additional mechanisms in the data store. The data store is operable, through logic associated therewith, to receive instructions from the application server and obtain, update or otherwise process data in response thereto. In one example, a user might submit a search request for a certain type of item. In this case, the data store might access the user information to verify the identity of the user and can access the catalog detail information to obtain information about items of that type. The information can then be returned to the user, such as in a results listing on a Web page that the user is able to view via a browser on the user device. Information for a particular item of interest can be viewed in a dedicated page or window of the browser.

Each server typically will include an operating system that provides executable program instructions for the general administration and operation of that server and typically will include computer-readable medium storing instructions that, when executed by a processor of the server, allow the server to perform its intended functions. Suitable implementations for the operating system and general functionality of the servers are known or commercially available and are readily implemented by persons having ordinary skill in the art, particularly in light of the disclosure herein.

The various embodiments can be further implemented in a wide variety of operating environments, which in some cases can include one or more user computers or computing devices which can be used to operate any of a number of applications. User or client devices can include any of a number of general purpose personal computers, such as desktop or laptop computers running a standard operating system, as well as cellular, wireless and handheld devices running mobile software and capable of supporting a number of networking and messaging protocols. Such a system can also include a number of workstations running any of a variety of commercially-available operating systems and other known applications for purposes such as development and database management. These devices can also include other electronic devices, such as dummy terminals, thin-clients, gaming systems and other devices capable of communicating via a network.

In embodiments utilizing a server, the server can run any of a variety of server or mid-tier applications, including HTTP servers, FTP servers, CGI servers, data servers, Java servers and business application servers. The server(s) may also be capable of executing programs or scripts in response requests from user devices, such as by executing one or more Web applications that may be implemented as one or more scripts or programs written in any programming language, such as Java®, C, C #or C++ or any scripting language, such as Perl, Python or TCL, as well as combinations thereof. The server(s) may also include database servers, including without limitation those commercially available from Oracle®, Microsoft®, Sybase® and IBM® as well as open-source servers such as MySQL, Postgres, SQLite, MongoDB, and any other server capable of storing, retrieving and accessing structured or unstructured data. Database servers may include table-based servers, document-based servers, unstructured servers, relational servers, non-relational servers or combinations of these and/or other database servers.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (SAN) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch-sensitive display element or keypad) and at least one output device (e.g., a display device, printer or speaker). Such a system may also include one or more storage devices, such as disk drives, magnetic tape drives, optical storage devices and solid-state storage devices such as random access memory (RAM) or read-only memory (ROM), as well as removable media devices, memory cards, flash cards, etc.

Such devices can also include a computer-readable storage media reader, a communications device (e.g., a modem, a network card (wireless or wired), an infrared communication device) and working memory as described above. The computer-readable storage media reader can be connected with, or configured to receive, a computer-readable storage medium representing remote, local, fixed and/or removable storage devices as well as storage media for temporarily and/or more permanently containing, storing, transmitting and retrieving computer-readable information. The system and various devices also typically will include a number of software applications, modules, services or other elements located within at least one working memory device, including an operating system and application programs such as a client application or Web browser. It should be appreciated that alternate embodiments may have numerous variations from that described above. For example, customized hardware might also be used and/or particular elements might be implemented in hardware, software (including portable software, such as applets) or both. Further, connection to other computing devices such as network input/output devices may be employed.

Storage media and other non-transitory computer readable media for containing code, or portions of code, can include any appropriate media known or used in the art, such as but not limited to volatile and non-volatile, removable and non-removable media implemented in any method or technology for storage of information such as computer readable instructions, data structures, program modules or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices or any other medium which can be used to store the desired information and which can be accessed by a system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the invention as set forth in the claims.

1. A computer-implemented method, comprising:
receiving a request, at an authentication service, to add an asset to a distributed ledger;
requesting, from a user, authentication information associated with the asset;
receiving, responsive to the request, the authentication information;
determining, based at least in part on one or more features of the authentication information and a category of the asset, that the authentication information fails to meet one or more threshold sufficiency factors;
providing, to the user, one or more recommendations to obtain supplemental authentication information;
receiving, supplemental authentication information;
determining, based at least in part on one or more features of the supplemental authentication information, that the supplemental authentication information exceeds the one or more threshold sufficiency factors; and
generating, for the asset, an entry in a distributed ledger including at least ownership information for the asset and an authentication status of the asset based, at least in part, on the authentication information and the supplemental authentication information.

2. The computer-implemented method of claim 1, where the one or more recommendations includes a list of expert.

3. The computer-implemented method of claim 1, wherein the asset is a physical asset.

4. The computer-implemented method of claim 1, further comprising:
listing the asset for sale in an online marketplace; and
determining, based at least in part on the entry, the authentication status of the asset; and
providing an indicator, within the online marketplace, of the authentication status.

5. The computer-implemented method of claim 1, further comprising:
receiving a request, from a lender, for one or more collateral assets;
determining, from the request, a category of collateral assets corresponds to the category of the asset; and
providing, to the user, a notification associated with the request.

6. The computer-implemented method of claim 5, wherein the request corresponds to a request to provide an interest rate in exchange for using the asset as collateral.

7. The computer-implemented method of claim 5, further comprising:
receiving, from the user, a response to the request, the response agreeing to provide the asset as collateral; and
updating the entry indicative of terms of the request.

8. A system, comprising:
at least one processor;
a memory device, the memory device storing instructions that, when executed by the at least one processor, cause the system to:
receive a request, from a user owning one or more assets, to enter into a transaction;
transmit the request to one or more transacting entities;
provide, to the one or more transacting entities; information associated with the one or more assets, the information stored on a distributed ledger and including at least ownership information and an authenticity status of the one or more assets;
receive, from the one or more transacting entities; a set of terms associated with the transaction;
provide, to the user, the set of terms;
receiving, from the user, a selection from the set of terms; and
updating an entry in the distributed ledge corresponding to the one or more assets to reflect the selection.

9. The system of claim 8, wherein the instructions, when executed by the at least one processor, further cause the system to:
determine, from the entry in the distributed ledger, that the authentication status is a verified.

10. The system of claim 8, wherein the authentication status is based, at least in part, on an evaluation of the one or more assets by a verified expert.

11. The system of claim 8, wherein the authentication status is based, at least in part, on information provided by at least one of a manufacturer or distribution of the one or more assets.

12. The system of claim 8, wherein the user maintains possession of the one or more assets after accepting the selection.

13. The system of claim 8, wherein the set of terms includes at least one of a usage restriction, a sale restriction, a maintenance requirement, or an insurance requirement.

14. The system of claim 8, wherein the instructions, when executed by the at least one processor, further cause the system to:
determine respective terms of the selection;
determine the user is in default; and
update the entry in accordance with the default.

15. The system of claim 14, wherein default transfers ownership of the one or more assets to a respective transacting entity associated with the selection.

16. The system of claim 8, wherein the instructions, when executed by the at least one processor, further cause the system to:
determine respective terms of the selection;
determine the user is has completed the respective terms; and
update the entry in accordance with the completion of the respective terms to clear title of the one or more assets.

17. A method, comprising:
receiving a request, at an online marketplace, to add an asset for sale within the online marketplace;
determining, based at least in part on the request, an entry within a distributed ledger associated with the asset;
verifying one or more features of the asset based, at least in part, on the entry; and
listing the asset within the online marketplace.

18. The method of claim 17, wherein the one or more features correspond to an authentication status of the asset.

19. The method of claim 17, further comprising:
receiving a second request to add a second asset for sale within the online marketplace;
determining, based at least in part on the second request, a second entry within the distributed ledger associated with the second asset;
determining a verification of one or more features of the asset, based at least in part on the second entry, is insufficient; and
preventing the second asset from being listed within the online marketplace.

20. The method of claim 19, further comprising:
notifying a user associated with the second request of the failed verification; and
providing recommendations to cure the failed verification.
